(19) United States
(12) Patent Application Publication
(10) Pub. No.: US 2014/0230644 A1
(43) Pub. Date: Aug. 21, 2014

(54) ACTUATOR APPARATUS AND A METHOD FOR INTEGRATING THIS ACTUATOR INTO TURBOMACHINERY

(71) Applicant: Nuovo Pignone S.p.A, Florence (IT)

(72) Inventor: Giuseppe Iurisci, Firenze (IT)

(21) Appl. No.: 14/347,758

(22) PCT Filed: Sep. 26, 2012
(86) PCT No.: PCT/EP2012/069002

§ 371 Date: Mar. 27, 2014

(30) Foreign Application Priority Data
Sep. 28, 2011 (IT) CO2011A000038

(51) Int. Cl. F15B 15/28

(52) U.S. Cl. CPC F15B 15/28
USPC 91/61; 29/888

(57) ABSTRACT

Apparatus and method for integrating an actuator into turbo-machinery and operating the actuator based on process fluid associated with the turbo-machinery. The integrated actuator mechanism includes an actuator casing; a balance drum, with labyrinth seals, and recovery spring, configured to apply force to the balance drum, in the actuator casing; an actuation bar connected to the balance drum and configured to move linearly in the direction of the balance drum; and a connection mechanism connecting a diverted portion of turbo-machinery process fluid to the actuator casing for applying force, in an opposite direction of the spring force, to the balance drum. The labyrinth seals allow the diverted turbo-machinery process fluid to bleed through and return to the turbo-machinery.

### BACKGROUND OF THE INVENTION

Embodiments of the subject matter disclosed herein generally relate to methods and devices and, more particularly, to mechanisms and techniques for actuating one or more moveable systems of turbo-machinery.

Turbo-machinery generally has internal rotating components, typically vanes for example, which are adjustable based on the operating conditions of the turbo-machinery. In an automated system, adjusting the moveable components requires the use of an actuator attached to a lever connected to the moveable components. In available actuator solutions, as shown in prior art FIG. 1, the actuator 102 is mounted on the outside of the turbo-machinery and the mechanical connection to the lever must pass through the turbo-machinery casing 108. This design requirement exposes one of the problem areas that market pressure is pushing to change, the expensive and complicated sealing flange 106, 108 requirements for connecting the actuator arm to the lever and passing the actuator/lever connection through the casing of the turbo-machinery.

In another aspect of current design technology, a control element power source must be provided to the actuator 102 to operate the actuator's motion. For example, the actuator 102 can be powered by electricity, hydraulic fluid or pneumatically, but whatever the source, wires, lines or pipes must be run from the power provider to the actuator 102 on the turbo-machinery. In a further issue, the external power source provides another possible element of risk for turbo-machinery downtime based on the loss of the medium powering the actuator 102.

Another issue associated with externally mounted actuators 102 on turbo-machinery is the risk of process gas leaking from the flange seals 106, 108 where the actuator 102 arm passes through the turbo-machinery casing 108 or from the actuator 102 directly. In some cases the process gas can be flammable, toxic, extremely high temperature, etc., leading to a significant event if the seal should fail and allow the process gas to vent to the atmosphere. Further, when an actuator 102 is protruding from the turbo-machinery casing 108, there is a risk that the actuator 102 can be contacted by other equipment and damaged, leading to an inoperative turbo-machinery and catastrophic venting of process gas to the atmosphere.

Accordingly, it would be desirable to provide devices and methods that avoid the afore-described problems and drawbacks.

### BRIEF DESCRIPTION OF THE INVENTION

According to one exemplary embodiment, there is an actuator casing comprising a balance drum fitted to an inside surface of the actuator casing, a first connection on the actuator casing configured to allow a fluid to enter the actuator casing and exert a first force on the balance drum, a recovery spring configured to exert a second force on the balance drum and a second connection on the actuator casing configured to allow the fluid to exit the actuator casing. In one aspect of the exemplary embodiment, an actuation bar is connected to the balance drum. In another aspect of the exemplary embodiment, a regulation valve is in a line associated with the first connection and controls the flow of fluid to the first connection.

According to another exemplary embodiment, there is a casing enclosing turbo-machinery and an actuator seamlessly integrated into the casing and configured to adjust an inflow of a fluid. The exemplary embodiment continues with an actuator comprising an actuator casing including a balance drum, a first connection on the actuator casing configured to allow a fluid to enter the actuator casing and exert a first force on the balance drum, a recovery spring configured to exert a second force on the balance drum and a second connection on the actuator casing configured to allow the fluid to exit the actuator casing. Continuing with the exemplary embodiment, an actuation bar is connected to the balance drum on one end and to a lever of an actuator ring on the other end. Next in the exemplary embodiment, a regulation valve in a line associated with the first connection and controlling the fluid flow to the first connection.

According to another exemplary embodiment, there is a method for seamlessly integrating an actuator into turbo-machinery. The method includes constructing a turbo-machinery casing to seamlessly include an actuator casing. Next in the exemplary embodiment, inserting a balance drum fitted to the actuator casing. Continuing with the exemplary embodiment, configuring a recovery spring to apply a first force the balance drum. The exemplary embodiment continues with connecting an actuation bar to the balance drum and to a lever associated with the turbo-machinery such that the actuation bar moves linearly in the direction moved by the balance drum. Continuing with the exemplary embodiment, diverting a portion of the turbo-machinery process fluid through a regulation valve and into the actuator casing to apply a second force to the balance drum, opposite of the first force.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a prior art exemplary embodiment of turbo-machinery with an actuator attached to an external flange;

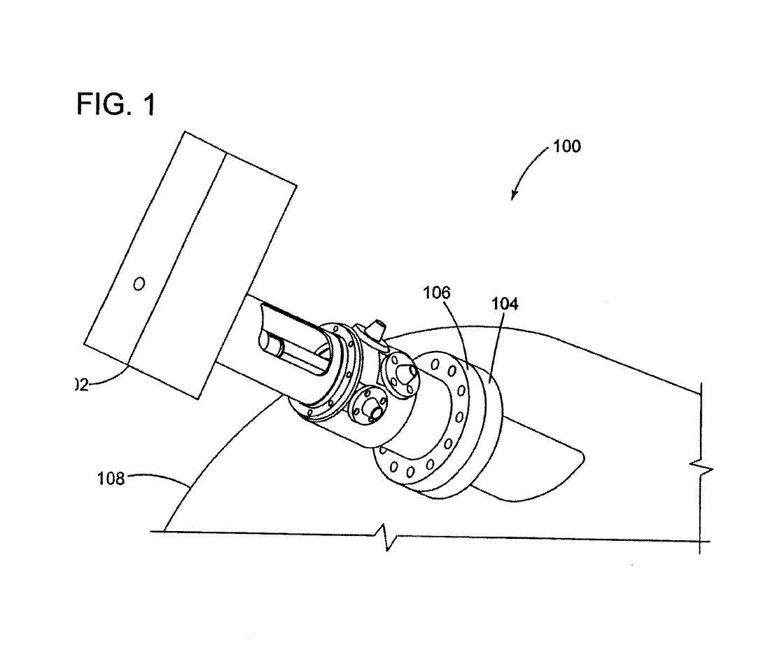

FIG. 2 is an exemplary embodiment of turbo-machinery with an integrated actuator; and

FIG. 3 is a flow chart illustrating steps for operating an actuator integrated with turbo-machinery according to an exemplary embodiment.

### DETAILED DESCRIPTION OF THE EXEMPLARY EMBODIMENTS OF THE INVENTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of turbo-machinery including but not limited to compressors and expanders.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

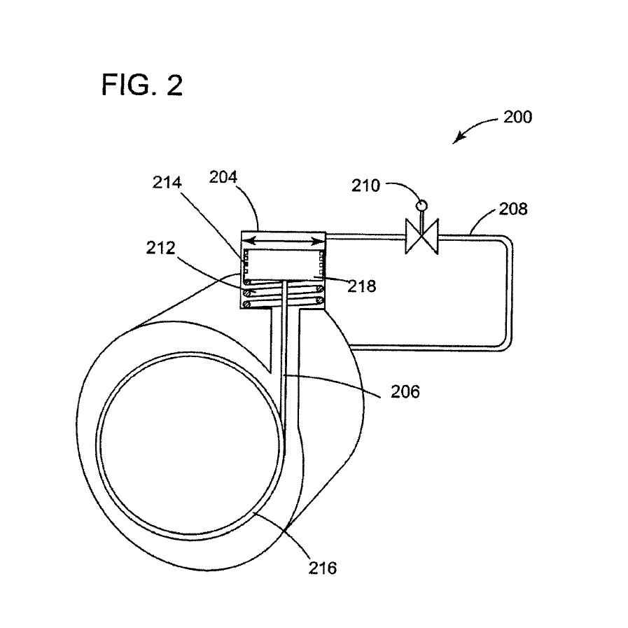

As shown in FIG. 2, an exemplary embodiment 200 depicts turbo-machinery with an integrated actuator 204. In one aspect of the exemplary embodiment, the turbo-machinery casing 202 and the integrated actuator are a single component shell of the turbo-machinery without the requirement of connecting flanges. It should be noted in the exemplary embodiment that the integrated actuator 204 can appear as an appendage to the turbo-machinery casing but does not have any seams with the turbo-machinery requiring sealing. In another aspect of the exemplary embodiment, the integrated actuator can be incorporated into the turbo-machinery such that there is no visible indication of an integrated actuator 204.

Continuing with the exemplary embodiment, the integrated actuator is powered by the difference in pressure of the process fluid under operation of the turbo-machinery. For example, a compressor with a difference in gas pressure between the inlet and the outlet can power the integrated actuator 204. In another aspect of the exemplary embodiment, the turbo-machinery with an integrated actuator 204 includes an actuation bar 206, a power fluid delivery line 208, a pressure regulation valve 210, a recovery spring 212, labyrinth seals 214 and an actuator balance drum 218. It should be noted in the exemplary embodiment, that the power fluid delivery line 208 is connected to a high pressure P2 location on the turbo-machinery, through the pressure regulation valve 210, then to the actuator 204 on one side of the balance drum 218. It should further be noted that because of the labyrinth seals 214 on the balance drum 218, the power fluid can bleed around the balance drum 218 and along the actuator bar 206 to return to a low pressure P1 location on the turbo-machinery. In a further aspect of the exemplary embodiment, the power fluid pressure P1 can be reduced downstream of the pressure regulation valve 210 to PB based on the setting of the pressure regulation valve 210.

Next in the exemplary embodiment, the actuator bar 206 is connected to the balance drum 218 and moves linearly in the direction of the balance drum 218 as the balance drum 218 moves. In another aspect of the exemplary embodiment, the balance drum 218 is balanced between the force of the power fluid acting on one side under the pressure PB of the power fluid and the force acting on the opposite side of the balance drum 218 exerted by recovery spring 212. It should be noted in the exemplary embodiment that the recovery spring can also be connected on the same side of the balance drum 218 as the force from the power fluid but apply the recovery spring force in a direction opposite of the power fluid force. Continuing with the exemplary embodiment, the recovery spring 212 returns the balance drum 218 and the attached actuator bar 206 to a startup position when the force of the power fluid is removed based on closing the regulation valve 210 or the shutdown of the turbo-machinery.

Accordingly, the exemplary embodiment describes controlling the linear position of the actuator bar 206 by controlling the position of the regulation valve 210. The actuator bar 206 can be connected to any lever accepting linear motion, in the direction of the balance drum 218, for operation. For example, the actuator bar 206 can be connected to a lever operating vanes on a compressor actuation ring 216 for optimizing performance of the compressor.

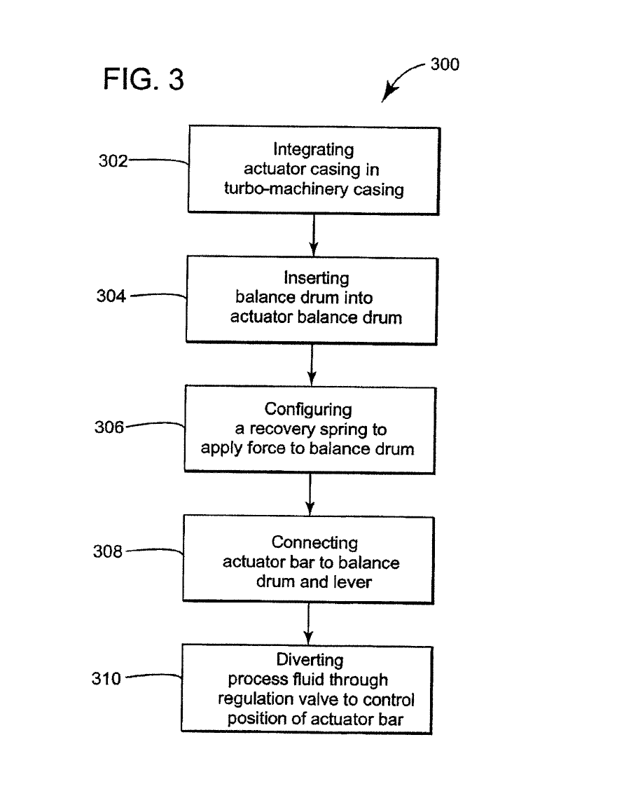

An exemplary method embodiment for integrating turbo-machinery with an actuator is now discussed with reference to FIG. 3. FIG. 3 shows exemplary method embodiment steps for integrating an actuator in turbo-machinery for operation based on pressure differences of process fluid in the turbo-machinery. The exemplary method embodiment includes a step 302 of integrating an actuator into the turbo-machinery casing. In one aspect of the exemplary embodiment, the actuator is visible as an appendage of the turbo-machinery casing but is an integrated component that does not have a seam or require a seal between the actuator and the turbo-machinery. In another aspect of the exemplary method embodiment, the actuator is completely enclosed within the turbo-machinery and is not distinguishable on the casing of the turbo-machinery.

Next at step 304 of the exemplary method embodiment, a balance drum is inserted into a cavity in the actuator casing. In another aspect of the exemplary method embodiment, a sealing system is placed between an outer surface of the balance drum and an inner surface of the actuator casing. It should be noted in the exemplary method embodiment that the sealing system can be, but is not limited to, a labyrinth seal. It should further be noted that the labyrinth seal, while restricting the flow of a fluid around the balance drum, does allow a fluid to bleed through and flow around the balance drum.

Continuing with step 306 of the exemplary method embodiment, a recovery spring is inserted into the actuator casing and placed adjacent to the balance drum such that the recovery spring imparts a force on the balance drum that displaces the balance drum to one end of the actuator casing. It should be noted in the exemplary method embodiment that the recovery spring can operate by imparting either a compressive or expansive force on the balance drum depending on the type of recovery spring and the connection to the balance drum. In another aspect of the exemplary method embodiment, regardless of the type of spring and the type of connection, when acting alone, the recovery spring force displaces the balance drum to a startup position for the turbo-machinery.

Next, step 308 of the exemplary method embodiment continues with connecting an actuation bar to the balance drum. It should be noted in the exemplary embodiment that the actuation bar moves in a linear motion in the direction of the movement of the balance drum. In another aspect of the exemplary embodiment, the process fluid that bleeds through the labyrinth seals and around the balance drum follows the path of the actuation bar back to a lower pressure area of the turbo-machinery. It should be noted be noted in the exemplary embodiment that the actuation bar serves as the connection point for delivery of the controlled motion to the turbo-machinery.

Continuing at step 310, the exemplary method embodiment diverts a portion of the higher pressure process fluid through a line connected to the actuator casing and containing a regulation valve. In the exemplary method embodiment the process fluid exerts the force of its pressure on the surface of the balance drum, in a direction opposite of the force exerted on the balance drum by the recovery spring. Continuing with the exemplary embodiment, the amount of force exerted by the process fluid pressure and the associated movement of the actuation bar is controlled by opening and closing the regulation valve based on the desired movement. For example, maximizing the output of a compressor can be accomplished by connecting the actuation bar to a lever controlling the vanes on an actuation ring and adjusting the regulation valve to position the vanes to optimize the throughput of the compressor. It should be noted in the exemplary embodiment that the labyrinth seals associated with the balance drum allow the process fluid to bleed around the balance drum and return to a lower pressure area of the turbo-machinery, in this manner, the process fluid can flow through the integrated actuator and allow the integrated actuator to automatically return to a startup setting when the turbo-machinery shuts down.

The disclosed exemplary embodiments provide a device and a method for integrating an actuator into turbo-machinery and operating the actuator based on a process fluid pressure gradient across the turbo-machinery. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements to those recited in the literal languages of the claims.

What is claimed is:

1. An actuator apparatus, comprising:
an actuator casing comprising:
a balance drum fitted to an inside surface of the actuator casing;
a first connection on the actuator casing configured to allow a fluid to enter the actuator casing and exert a first force on the balance drum;
a recovery spring configured to exert a second force on a first side of the balance drum; and
a second connection on the actuator casing configured to allow the fluid to exit the actuator casing;
an actuation bar connected to the balance drum; and
a regulation valve in a line associated with the first connection and controlling the fluid flow to the first connection.

2. The apparatus of claim 1, wherein the actuator casing further comprises a seal comprising a labyrinth seal, configured between an outside surface of the balance drum and an inside surface of the actuator casing.

3. The actuator of claim 1, wherein the recovery spring returns the balance drum to a startup position when the regulation valve is closed.

4. The actuator of claim 1, wherein the actuation bar moves in a linear direction associated with the balance drum's linear movement.

5. The apparatus of claim 1, wherein the actuation bar extends out of the actuator casing through the second connection.

6. The apparatus of claim 1, wherein the fluid at the first connection is at a higher pressure than the fluid at the second connection.

7. The actuator of claim 2, wherein the labyrinth seal allows the fluid to bleed around the balance drum.

8. The apparatus of claim 1, wherein the recovery spring exerts the second force on a second side of the balance drum opposite from the first side, and in a second direction opposite to said first direction.

9. An apparatus comprising:
a casing enclosing a turbo-machine; and
an actuator seamlessly integrated into the casing and configured to adjust an inflow of a fluid, wherein the actuator comprises:
an actuator casing comprising:
a balance drum fitted to an inside surface of the actuator casing;
a first connection on the actuator casing configured to allow a fluid to enter the actuator casing and exert a first force on the balance drum;
a recovery spring configured to exert a second force on the balance drum; and
a second connection on the actuator casing configured to allow the fluid to exit the actuator casing;
an actuation bar connected to the balance drum and to a lever associated with the turbo-machine; and
a regulation valve in a line associated with the first connection and controlling the fluid flow to the first connection.

10. A method for integrating an actuator into turbo-machinery, the method comprising:
constructing a turbo-machinery casing to include an actuator casing;
inserting a balance drum, fitted to the actuator casing, into the actuator casing;
configuring a recovery spring to apply a first force to the balance drum;
connecting an actuation bar to the balance drum, for movement associated with the balance drum movement, and to a lever associated with the turbo-machinery; and
diverting a portion of a turbo-machinery process fluid through a regulation valve and into the actuator casing to apply a second force to the balance drum opposite the first force and control a position of the actuation bar.

11. The apparatus of claim 9, wherein the actuator casing further comprises a seal comprising a labyrinth seal, configured between an outside surface of the balance drum and an inside surface of the actuator casing.

12. The actuator of claim 9, wherein the recovery spring returns the balance drum to a startup position when the regulation valve is closed.

13. The actuator of claim 9, wherein the actuation bar moves in a linear direction associated with the balance drum's linear movement.

14. The apparatus of claim 9, wherein the actuation bar extends out of the actuator casing through the second connection.

15. The apparatus of claim 9, wherein the fluid at the first connection is at a higher pressure than the fluid at the second connection.

16. The actuator of claim 11, wherein the labyrinth seal allows the fluid to bleed around the balance drum.

17. The apparatus of claim 9, wherein the recovery spring exerts the second force on a second side of the balance drum opposite from the first side, and in a second direction opposite to said first direction.
